(19) United States
(12) Patent Application Publication
(10) Pub. No.: US 2023/0046164 A1
(43) Pub. Date: Feb. 16, 2023

(54) Lithium-Ion Battery Core System

(71) Applicants: Trung Minh Tran, Round Rock, TX (US); Kevin Quang Tran, Round Rock, TX (US); Steven Minh Tran, Round Rock, TX (US)

(72) Inventors: Trung Minh Tran, Round Rock, TX (US); Kevin Quang Tran, Round Rock, TX (US); Steven Minh Tran, Round Rock, TX (US)

(21) Appl. No.: 17/832,083

(22) Filed: Jun. 3, 2022

Related U.S. Application Data
(60) Provisional application No. 63/231,319, filed on Aug. 10, 2021.

(51) Int. Cl. H01M 10/0525; H01M 50/264; H01M 10/48; H01M 10/44

(52) U.S. Cl. CPC H01M 10/0525; H01M 50/264; H01M 10/488; H01M 10/44

(57) ABSTRACT

The present invention is an improved lithium-ion battery core system for use within an electric vehicle. The present invention has a battery receiver and a battery charger. The battery receiver has a battery adaptor and a receiver lock. The battery adaptor allows the present invention to insert standardized lithium-ion cores that are managed at a specified voltage level suitable for the electric vehicle. The lithium-ion core includes a removable and rechargeable lithium-ion core, that can be charged by the battery charger. The battery charger has a plurality of cores, a plurality of lights, and an ejection button. The ejection button removes a battery from the battery charger. All of these various components allow for the present invention to provide users with a system for keeping electric vehicles properly charged for long distance travel.

### FIELD OF THE INVENTION

The present invention relates generally to a lithium-ion battery core system. More specifically, the present invention is a device that can improve usability, serviceability and increase the accessibility as well as distance of electric vehicles.

### BACKGROUND OF THE INVENTION

The automotive industry is constantly expanding and developing new technology to improve the quality of the automobiles produced. Throughout recent years the automotive industry has turned towards producing more environmentally friendly automobiles. The automotive industry currently produces automobiles with electrical batteries used to power and allow the vehicle to run. Unfortunately, many electrical vehicle batteries do not last for extended periods, resulting in the automobile to be limited in the distance the vehicle can travel in one charge. A typical electric vehicle battery lasts for four to six hours while travelling before needing a recharge, causing more issues for the user where finding charging stations along the road is increasingly difficult.

### BRIEF DESCRIPTION OF THE DRAWINGS

FIG. 1 is an illustration of the present invention.

FIG. 2 is a perspective view of the battery receiver.

FIG. 3 is a front view of the battery receiver.

### DETAIL DESCRIPTIONS OF THE INVENTION

All illustrations of the drawings are for the purpose of describing selected versions of the present invention and are not intended to limit the scope of the present invention.

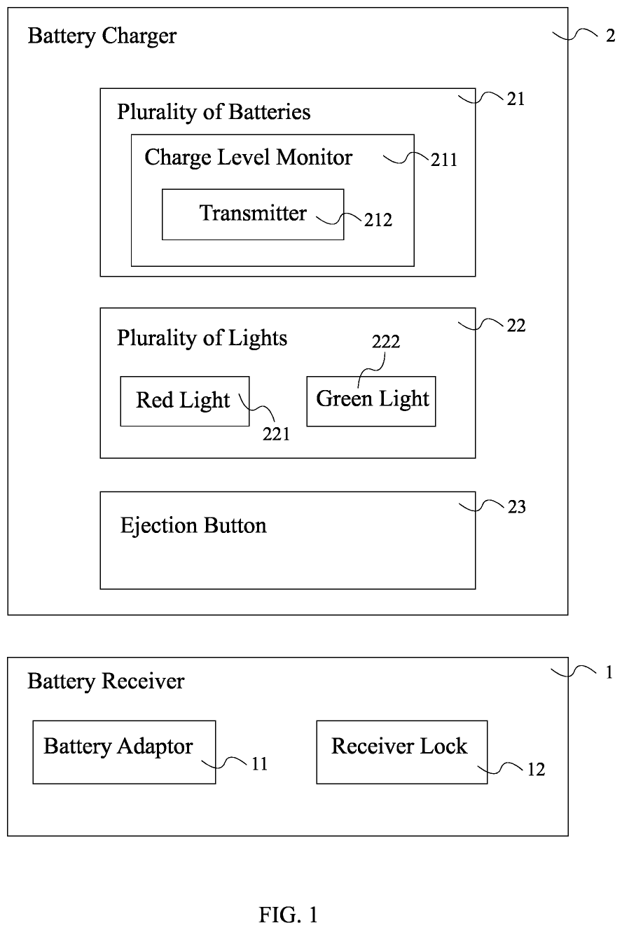

In reference to FIG. 1, the present invention is a lithium-ion battery core system. The preferred embodiment of the present invention comprises a battery receiver 1 (or battery envelop) and a battery charger 2. The battery receiver 1 comprises a battery adaptor 11 and a receiver lock 12. Each battery receiver can lock up to 3 battery cores and each core can be used for at least 8 hours. Think of EV core like any traditional AA battery. However, the differences are: Each EV′ core works independently; When one is empty, the EV will switch automatically to the next core; The total hour of cores determines the total hour that EV can operate. For example, if there are three cores are locked within the battery receiver with the same amount of 8-hour drive, the EV can operate up to 24 hours; Each core can last either 8 or 10 or 12 hours. Additionally, there is a LED indicate for each core, Green: core is in currently use; Red: Core is in slot and empty; Blue: Core is in slot but not in use; Pink: Core is in slot and only has about 1 hour left. The EV core can be inserted into a battery receiver 1 that transmits data to the dashboard of any vehicle. The data transmitted to the dashboard displays the amount of operating hours left for the EV core. The vehicle dashboard displays the full 24 hours that three EV cores provides when each EV core is inserted. This provides a visual display when once of the EV cores is not operating correctly and need replacing. In addition to buying an EV core at any gas station when the EV core runs out of charge the EV core can be charged at any standard charging station.

The battery adaptor 11 is an electrical component that converts electrical power to the required input level of an automobile. The core 21 slides into the battery charger 2. The receiver lock 12 secures a core 21 in place within the battery receiver 1. The battery charger 2 comprises a plurality of cores 21, a plurality of lights 22, and an ejection button 23. Each core 21 operates independently one after another and the plurality of lights 22 will indicate which core 21 is currently in use. Moreover, the plurality of cores 21 will be shown on Dashboard's LCD to allow the user to see the charge level of each core 21.

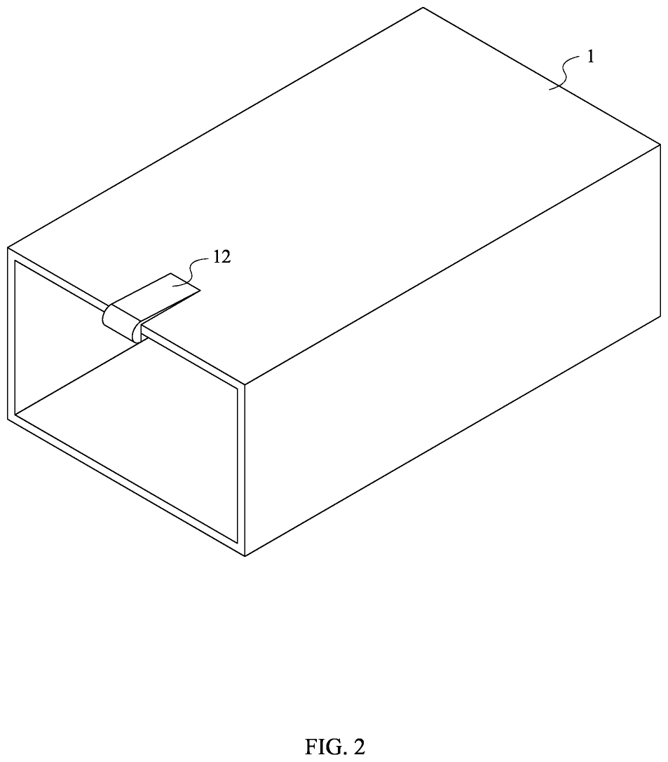

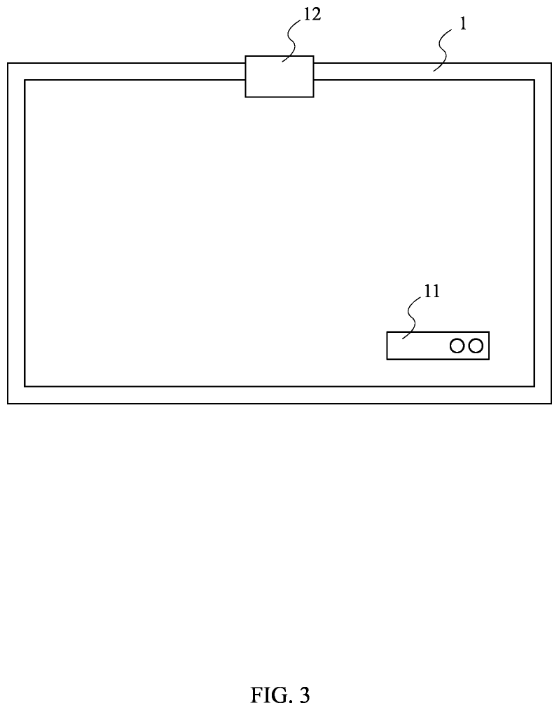

The ejection button 23 is a mechanical component that removes at least one core 21 from the battery charger 2. The plurality of cores 21 can be removed from the battery receiver 1 by opening the receiver lock 12. The battery adaptor 11 is integrated into the battery receiver 1. When a core is in use, the battery adapter 11 can convert electrical power for that core 21. Recalled, each core works independently. As a result, the battery adaptor 11 can convert electrical power from up to three cores 21 (one after another) placed within the battery receiver 1. Furthermore, the battery receiver can be replaced as needed similar to a standard battery. The receiver lock 12 is integrated into the battery receiver 1. Consequently, the receiver lock 12 secures at least one core 21 within the battery receiver 1. The battery adaptor 11 converts electrical current from at least one core 21. Accordingly, the battery adaptor 11 ensures that the electrical current from at least one core 21 is converted to a usable level for the automobile. As referenced in FIG. 2-3, the battery receiver 1 receives at least one core 21. Thus, the battery receiver 1 can secure and utilize at least any core 21 that is designed with a lithium-ion material. The receiver lock 12 mechanically secures at least one core 21. Therefore, the receiver lock 12 ensures a core 21 stays positioned within the batter receiver until needing to be removed by a user. The receiver lock 12 is positioned opposite the battery adaptor 11. As a result, the receiver lock 12 does not interfere with the battery adaptor 11 connecting to a core 21. Each battery core 21 can be inserted and fit into a battery receiver 1 made from any EV manufacturer.

Further, the plurality of cores 21 is electrically connected to the battery charger 2. Consequently, the plurality of cores 21 is provided with electrical energy from the battery charger 2 and can be replaced with any of the plurality of cores 21 when the charge is depleted. The plurality of lights 22 is electrically integrated to the battery charger 2. Accordingly, the plurality of lights 22 provides a light source powered by the battery charger 2. The ejection button 23 is mechanically integrated to the battery charger 2. Thus, as referenced in FIG. 1, the ejection button 23 allows a core 21 to be ejected from the battery charger 2.

Furthermore, the plurality of cores 21 comprises a charge level monitor 211 as referenced in FIG. 1. The charge level monitor 211 is an electronic component that observes the amount of electrical energy left within at least one core 21. If the charge level monitor 211 detects an active core 21 is below 50% charged and the remaining plurality of cores 21 are empty a command will automatically be sent to the vehicle to search for nearby charging stations. The charge level monitor 211 is electronically connected to the plurality of cores 21. So, the charge level monitor 211 senses the electrical energy level within at least one core 21 and provides the data to a user via a vehicle dashboard connected to the present invention.

In reference to FIG. 1, the charge level monitor 211 comprises a transmitter 212. The transmitter 212 is an electronic device that wirelessly sends information. The transmitter 212 is electronically connected to the charge level monitor 211. As a result, the transmitter 212 sends information about the electrical energy within the at least one core 21 to the user via a dashboard within a vehicle selected by the user.

Further, the plurality of lights 22 comprises a red light 221 and a green light 222. The red light 221 in the preferred embodiment is a light emitting diode (LED) with a red color. The green light 222 in the preferred embodiment is a LED with a green color. The red light 221 is electrically connected to the battery charger 2 as referenced in FIG. 1. Consequently, the red light 221 notifies the user if at least one core 21 is still being charged via the battery charger 2. The green light 222 is electrically connected to the battery charger 2. Accordingly, the green light 222 notifies the user if at least one core 21 is finished charging via the battery charger 2. Further, the green light 222 or red light 221 can change color to a pink light or a yellow light. Furthermore, the green color indicates one of the plurality of cores 21 is inserted, yellow color indicates a 25% charge, pink color indicates a 0% charge, and red indicates no core 21 within the battery receiver 1.

Furthermore, the right light is mounted on the battery charger 2. Thus, the red light 221 can easily display the charging state of at least one core 21 within the battery charger 2. The green light 222 is mounted on the battery charger 2. Thus, as referenced in FIG. 1, the green light 222 can easily display the charging state of at least one core 21 within the battery charger 2.

In reference to FIG. 1, the red light 221 is positioned adjacent to the green light 222. Therefore, the red light 221 and green light 222 are easily distinguishable to the user and easily visible on the battery charger 2. The ejection button 23 is positioned offset the plurality of lights 22. As a result, the ejection button 23 does not interfere with plurality of lights 22. Further, in an alternative embodiment the battery receiver 1 can be used within a variety of different products and is not limited to just vehicles.

Although the invention has been explained in relation to its preferred embodiment, it is to be understood that many other possible modifications and variations can be made without departing from the spirit and scope of the invention as hereinafter claimed.

What is claimed is:

1. A lithium-ion battery core system comprising:
a battery receiver;
a battery charger;
the battery receiver comprising a battery adaptor and a receiver lock;
the battery charger comprising a plurality of cores, a plurality of lights, and a ejection button;
the battery adaptor being integrated into the battery receiver;
the receiver lock being integrated into the battery receiver;
the battery adaptor converting electrical current from at least one battery;
the battery receiver receiving at least one battery;
the receiver lock mechanically securing at least one battery; and
the receiver lock being positioned opposite the battery adaptor.

2. The lithium-ion battery core system as claimed in claim 1 comprising:
the plurality of cores being electrically connected to the battery charger;
the plurality of lights (green, blue, red, and pink) being electrically integrated to the battery charger; and
the ejection button being mechanically integrated to the battery charger.

3. The lithium-ion battery core system as claimed in claim 2 comprising:
the plurality of cores comprising a charge level monitor; and
the charge level monitor being electronically connected to the plurality of cores.

4. The lithium-ion battery core system as claimed in claim 3 comprising:
the charge level monitor comprising a transmitter; and
the transmitter being electronically connected to the charge level monitor.

5. The lithium-ion battery core system as claimed in claim 2 comprising:
the plurality of lights comprising a red light and a green light;
the red light being electrically connected to the battery charger; and
the green light being electrically connected to the battery charger.

6. The lithium-ion battery core system as claimed in claim 2 comprising:
the red light being mounted on the battery charger; and
the green light being mounted on the battery charger.

7. The lithium-ion battery core system as claimed in claim 2 comprising:
the red light being positioned adjacent to the green light; and
the ejection button being positioned offset the plurality of lights.

8. A lithium-ion battery core system comprising:
a battery receiver;
a battery charger;
the battery receiver comprising a battery adaptor and a receiver lock;
the battery charger comprising a plurality of cores, a plurality of lights, and a ejection button;
the battery adaptor being integrated into the battery receiver;
the receiver lock being integrated into the battery receiver;
the battery adaptor converting electrical current from at least one battery;
the battery receiver receiving at least one battery;
the receiver lock mechanically securing at least one battery;
the receiver lock being positioned opposite the battery adaptor;
the plurality of cores being electrically connected to the battery charger;
the plurality of lights being electrically integrated to the battery charger; and
the ejection button being mechanically integrated to the battery charger.

9. The lithium-ion battery core system as claimed in claim 8 comprising:
the plurality of cores comprising a charge level monitor; and
the charge level monitor being electronically connected to the plurality of cores.

10. The lithium-ion battery core system as claimed in claim 9 comprising:
the charge level monitor comprising a transmitter; and
the transmitter being electronically connected to the charge level monitor.

11. The lithium-ion battery core system as claimed in claim 8 comprising:
the plurality of lights comprising a red light and a green light;
the red light being electrically connected to the battery charger; and
the green light being electrically connected to the battery charger.

12. The lithium-ion battery core system as claimed in claim 8 comprising:
the red light being mounted on the battery charger; and
the green light being mounted on the battery charger.

13. The lithium-ion battery core system as claimed in claim 8 comprising:
the red light being positioned adjacent to the green light; and
the ejection button being positioned offset the plurality of lights.

14. A lithium-ion battery core system comprising:
a battery receiver;
a battery charger;
the battery receiver comprising a battery adaptor and a receiver lock;
the battery charger comprising a plurality of cores, a plurality of lights, and a ejection button;
the battery adaptor being integrated into the battery receiver;
the receiver lock being integrated into the battery receiver;
the battery adaptor converting electrical current from at least one battery;
the battery receiver receiving at least one battery;
the receiver lock mechanically securing at least one battery; and
the receiver lock being positioned opposite the battery adaptor.

15. The lithium-ion battery core system as claimed in claim 14 comprising:
the plurality of cores being electrically connected to the battery charger;
the plurality of lights being electrically integrated to the battery charger; and
the ejection button being mechanically integrated to the battery charger.

16. The lithium-ion battery core system as claimed in claim 15 comprising:
the plurality of cores comprising a charge level monitor; and
the charge level monitor being electronically connected to the plurality of cores.

17. The lithium-ion battery core system as claimed in claim 16 comprising:
the charge level monitor comprising a transmitter;
the transmitter being electronically connected to the charge level monitor;
the plurality of lights comprising a red light and a green light;
the red light being electrically connected to the battery charger; and
the green light being electrically connected to the battery charger.

18. The lithium-ion battery core system as claimed in claim 15 comprising:
the red light being mounted on the battery charger; and
the green light being mounted on the battery charger.

19. The lithium-ion battery core system as claimed in claim 15 comprising:
the red light being positioned adjacent to the green light; and
the ejection button being positioned offset the plurality of lights.

20. The lithium-ion battery core system as claimed in claim 1 comprising:
the plurality of cores being removable from battery receiver and rechargeable; and
the plurality of cores lasting 8, 10, or 12 hours before running out of electrical charge.
